(19) United States
(12) Patent Application Publication
(10) Pub. No.: US 2015/0266045 A1
(43) Pub. Date: Sep. 24, 2015

(54) INJECTOR NOZZLE

(71) Applicants: Oliver BUCK, Metzingen (DE); Thomas SCHENK, Neuffen (DE); Joaquim GOMES-ALVES, Reutlingen (DE)

(72) Inventors: Oliver BUCK, Metzingen (DE); Thomas SCHENK, Neuffen (DE); Joaquim GOMES-ALVES, Reutlingen (DE)

(21) Appl. No.: 14/661,733

(22) Filed: Mar. 18, 2015

(30) Foreign Application Priority Data
Mar. 24, 2014 (DE) 10 2014 205 399.4

(51) Int. Cl. B05B 15/06

(52) U.S. Cl. CPC B05B 15/065

(57) ABSTRACT

An injector nozzle having a housing, an interior space of the housing being defined in sections by a housing wall, and having an injector component arranged in the interior space of the housing at least in sections, wherein the housing wall has at least one through hole, the at least one through hole being appropriate for a human finger to reach in, at least in sections, and wherein the injector component has at least one handle portion, which handle portion is accessible via the through hole.

### CROSS-REFERENCE TO RELATED APPLICATIONS

This application claims the priority of German Application No. 10 2014 205 399.4, filed on Mar. 24, 2014, the disclosure of which is hereby incorporated by reference in its entirety into this application.

### FIELD OF THE INVENTION

The invention relates to an injector nozzle having a housing and having an injector component arranged in the interior space of the housing at least in sections.

### BACKGROUND AND SUMMARY OF THE INVENTION

An aim of the invention is to provide an improved injector nozzle.

According to the invention, an injector nozzle having a housing and having an injector component arranged in the interior space of the housing at least in sections is provided, wherein the injector component has at least one handle portion which is accessible from the outer side of the housing.

Owing to the fact that the injector component or a handle portion of the injector component is accessible from the outer side of the housing, the injector component can be removed from the housing of the injector nozzle in a simple manner without using a tool. An essential feature thereby is that the handle portion of the injector component is accessible from an outer side of the housing in such a way that, even with the housing taken off from a nozzle support, the injector component does not have to be grasped from the inflow side, but may be grasped simply from the outer side of the housing at the handle portion, and may be pushed out of the housing counter to the flow direction, for example.

In an advanced embodiment of the invention, the housing has at least one through hole, wherein the at least one through hole is appropriate for a human finger to reach in, at least in sections, and wherein the handle portion of the injector component is accessible via the through hole.

By providing a through hole and a handle portion on the injector component, the injector component can be removed from the housing of the injector nozzle in a very simple manner without using a tool. Said feature is very advantageous in particular for use in agricultural technology.

Occasionally, injector components of injector nozzles need to be replaced or disassembled for cleaning. The possibility to remove the injector component of the injector nozzle according to the invention from the housing without using a tool, facilitates such maintenance procedures considerably and allows such operations to be accomplished in a short time and without difficulty, even during field work. Attention should be paid to the fact that in agricultural technology there is, in general, need to wear protective gloves due to the spraying of agricultural chemicals. As a result, handling of tools is awkward so that by providing the invention, a considerable improvement in the handling of an injector nozzle is achieved.

In an advanced embodiment of the invention, a housing wall has two opposite through holes.

In this manner, an operator is enabled to grasp one or two handle portions of the injector component in a pinch grip using two fingers reaching through the two opposite through holes. Thereby, even comparatively high operating forces can be applied and the injector component can reliably be removed from the housing without a tool.

In an advanced embodiment of the invention, the at least one through hole is in a rectangular or oval shape.

Upon inserting the injector component into the housing, a rectangular or oval through hole provides a certain sliding path. In this case, a longer side or dimension of the through holes is parallel to the exit direction of the injector.

In an advanced embodiment of the invention, the injector component has corrugations at least in a region that is located in the vicinity of the at least one through hole of the housing in the assembled state.

By means of corrugation, the feel of the handle portion can be improved essentially so that, even with gloved fingers, the injector component can be removed without difficulty.

In an advanced embodiment of the invention, the injector component has a mixing chamber housing which together with an inner wall of the nozzle housing constitutes an air intake compartment, and at least one operating piece disposed at a distance to the mixing chamber housing and arranged in the vicinity of the at least one through hole of the housing, in the assembled state of the injector component.

In this manner, the operating piece with the handle portion can be arranged within the housing, and there is a zone of the air intake compartment defined between the operating piece and the mixing chamber housing.

In an advanced embodiment of the invention, the housing has two opposite through holes and the injector component has two opposite operating pieces each provided with a handle portion.

Providing two opposite handle portions allows not only reliable grasping and displacing of the injector component, but also there is application of force symmetrical to the injector component during sliding out of the latter, such that there is no risk of jamming or tilting of the injector component during sliding out. In any case, due to the symmetrical application of force on the opposite operating pieces, even a tight sitting injector component may be moved out of the housing reliably and without using a tool.

In an advanced embodiment of the invention, the at least one operating piece with the handle portion extends from a flange connected to the mixing chamber housing and projects freely beyond the flange.

In this manner, the operating pieces can be disposed immediately behind the inner wall of the housing and in the vicinity of the through holes and, all the same, there remains room for a sufficiently large air intake compartment between the operating pieces and the mixing chamber housing. Advantageously, the flange is a disc-shaped ring or an annular flange.

### BRIEF DESCRIPTION OF THE DRAWINGS

Further features and advantages of the invention will become apparent from the claims and the following description of a preferred embodiment of the invention in connection with the drawings. In the drawings:

FIG. 1 shows an isometric, partially schematical illustration obliquely from below of a spray device according to the invention including an injector nozzle according to the invention;

FIG. 2 shows an expanded, sectional illustration of the injector nozzle according to the invention of FIG. 1;

FIG. 3 shows a sectional illustration of the injector nozzle according to FIG. 1 in the assembled state;

FIG. 4 shows an isometric illustration of a housing and a mouthpiece of the injector nozzle according to FIG. 1; and

FIG. 5 shows an isometric illustration of an injector component adapted to be inserted into the housing according to FIG. 4.

### DETAILED DESCRIPTION

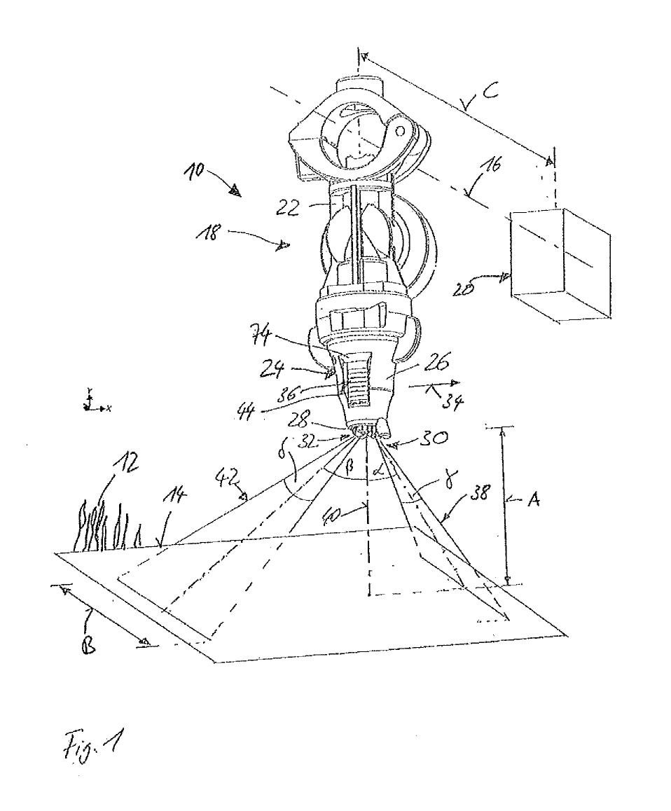

The illustration of FIG. 1 shows a spray device 10 according to the invention which is intended for spraying crop plants 12 on a soil surface 14. The line of sight of a viewer in FIG. 1 is from obliquely below to the spray device 10 and to the soil surface 14, that is, the viewer is positioned on an imaginary point below the soil surface 14 in FIG. 1. The spray device 10 is illustrated only schematically and includes a distributor tube, illustrated in FIG. 1 by not more than its central longitudinal axis 16. On the distributor tube, multiple nozzle devices 18, 20 are disposed, wherein the second nozzle device 20 is indicated merely schematically in the form of a rectangular block. Each of the nozzle devices 18, 20 has a nozzle support 22 and a double flat spray nozzle 24 designed as an injector nozzle. The double flat spray nozzle 24 is attached on a matching connector flange of the nozzle support 22 via a bayonet coupling, which support in turn is disposed on the distributor tube and is to supply an agricultural chemical to be sprayed to the double flat spray nozzle 24. The double flat spray nozzle 24 or injector nozzle has a housing 26 which is provided with a nozzle mouthpiece 28 including a first outlet opening 30 and a second outlet opening 32. The spray device 10 is moved across the soil surface 14 along a movement direction 34. An injector component 36 is arranged in the nozzle housing 26 and in FIG. 1 merely portions thereof are visible. By means of the injector component 36, air is admixed to the agricultural chemical to be sprayed within the nozzle housing 26 so that coarse drops are ejected from the outlet openings 30, 32 and said drops are subject to not more than minor drift caused by wind.

A flat jet 38 exits from the first outlet opening 30 and has an output angle α to a central longitudinal axis 40 of the housing 26 of the double flat spray nozzle 24. Said first flat jet 38 has a jet angle γ.

A second flat jet 42 exits from the second outlet opening 32. Said second flat jet 42 has an output angle β to a central longitudinal axis 44 of the housing 26. Said second flat jet 42 has a jet angle δ.

The outlet openings 30, 32 and, thus, the bottom end of the housing 26 in FIG. 1 are disposed at a distance A from the soil surface 14. The flat jets 40, 42 are impacting on the soil surface 14 with a jet width B, wherein the jet widths B of the two flat jets 40, 42 on the soil surface 14 are identical in size with the double flat spray nozzle 24 according to the invention. With the double flat spray nozzle 24, the output angles α, β and the jet angles γ, δ of the two flat jets 40, 42 outputted from the outlet openings 30, 32 are matched to one another in such a manner that at a distance A and, thus, on the soil surface 14, both the flat jets 40, 42 have the same jet width B.

The two nozzle devices 18, 20 are disposed at a distance C along the central longitudinal axis 16 of the distributor tube. Said distance C is matched to the jet width B in such a manner that the flat jets of the respective double flat spray nozzles are overlapping in a marginal region.

In the illustration of FIG. 1, merely a handle portion 44 of the injector component 36 is visible, which has corrugations and is located in the vicinity of a through hole 46 of the housing 26. The handle portion 44 is arranged directly behind the through hole 46 which is in a rectangular shape. A longer extension of the through hole 46 is parallel to the central longitudinal axis 40 of the housing 26. The handle portion 44 can be grasped by a human finger reaching through the through hole 46 and, thereby, the injector component 36 in FIG. 1 can be pushed upwards and out of the housing 26, what will be explained in more detail below. Of course, this is feasible only in case that the housing 26 is taken off the nozzle support 22.

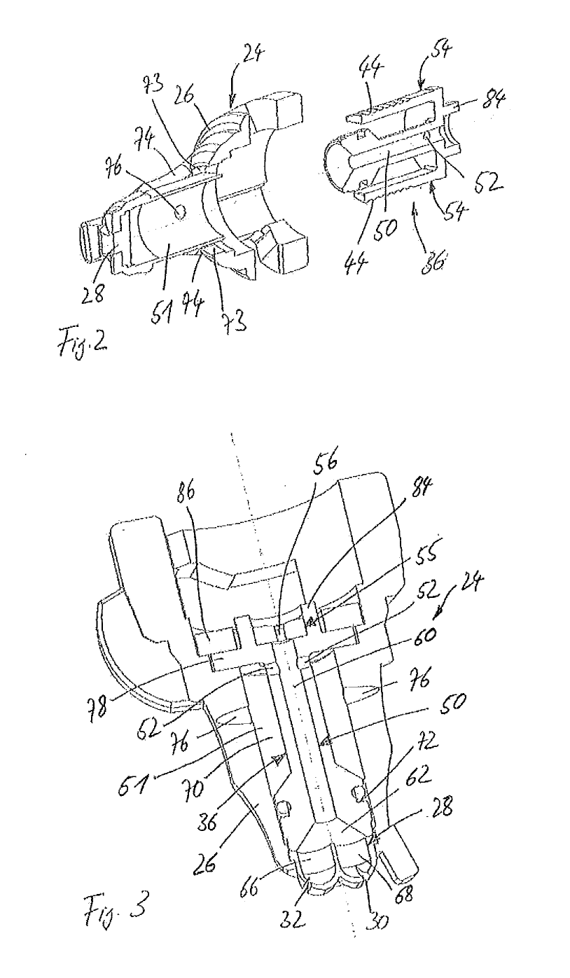

The illustration of FIG. 2 shows the double flat spray nozzle 24 or injector nozzle according to FIG. 1 in a sectional view and in an expanded illustration. Hence, in the illustration, the injector component 36 is located outside the housing 26, whereas the nozzle mouthpiece 28 is already inserted in the housing 26.

The injector component 36 has a mixing chamber 50 which chamber has an initially circular cylindrical cross section and is then conically enlarging along the outflow direction. The agricultural chemical is injected into the mixing chamber 50 in the form of a single spray jet from the end located on the right hand side in FIG. 2 via a baffle not illustrated in FIG. 2. Said spray jet produces, in the vicinity of its input, a negative pressure in the mixing chamber 50 to thereby entrain air, which air can enter into the mixing chamber 50 via an air ventilation opening 52. A second air ventilation opening 52 is located opposite thereto, but not visible in FIG. 2.

The injector component 36 is provided with two operating pieces 54 which are located one opposite to the other and accessible via the through holes 46 of the housing 26 in the vicinity of the respective handle portion 44, as is apparent from FIG. 1 in sections. By means of the operating pieces 54, the injector component can be removed from the housing without using a tool and installed back again, respectively. For that purpose, the injector component 36 is pushed into the housing from the side of the housing 26 located upstream in the outflow direction, as is apparent from FIG. 2. For pushing the injector component 36 out, the component is gripped with two fingers on the handle portions 44 and then pushed out of the housing 26, that is, counter to the outflow direction, towards the right hand side in FIG. 2.

The housing 26 has a circular cylindrical interior space 51 into which the portion of the injector component 36 constituting the mixing chamber 50 is inserted. Said interior space 51 is provided with two air ventilation openings 76 for communicating connection of the interior space to the environment. Between the mixing chamber portion of the injector component 36 and the inner wall of the interior space 51, there is an annular gap space 70 produced in the assembled state, cf. FIG. 3, the annular gap being in communication with the environment via the air ventilation openings 76, cf. FIG. 3. The housing 26 includes the two rectangular through holes 46, as viewed from the housing exterior, however, said holes are not open towards the interior space 51, but merely penetrate the exterior shell of the housing 26 and allow access to an outer wall of the circular cylindrical interior space 51 in the disassembled state according to FIG. 2. Located between an upstream portion of the housing 26 and the outer wall of the interior space 51 in the vicinity of the through holes 46, there is a respective slot 73 into which the operating pieces 54 of the injector component 36 are inserted from the right hand side according to FIG. 2. Thus, in the assembled state of the double flat spray nozzle according to the invention, the portion of the injector component 36 constituting the mixing chamber 50 is located within the interior space 51, whereas the operating pieces 54 are located outside the interior space and the handle portions 44 with corrugations on the operating pieces 54 are accessible through the through holes 74 of the housing 26.

In order to insert the injector component 36 into the housing 26, the component is pushed into the housing 26 along the flow direction. In order to remove the injector component 36 again from the housing 26, for example, to replace it because of wearout or obstruction, all that needs to be done is grasping the handle portions 44 of the operating pieces 54 by reaching through the through holes 74 and displacing them counter to the outflow direction. In that context, the through holes 74 are dimensioned such that a human thumb or a human index finger may reach through the through holes 74 and get hold of the handle portions 44 of the operating pieces 54. Thereby, the injector component 36 can be removed from the housing 26 and installed back therein in a very simple manner, even with a gloved hand, without using a tool.

In the illustration according to FIG. 2, the injector component 36 is not yet provided with a baffle 55, cf. FIG. 3, which then defines an inlet opening 56 for a fluid jet into the mixing chamber 50.

The illustration according to FIG. 3 shows a sectional view of the double flat spray nozzle 24 in the assembled state, wherein a sectional plane is approximately perpendicular to the sectional plane of FIG. 2. The mouthpiece 28 is installed in the housing.

During operation, a liquid jet enters into the circular cylindrical portion 60 of the mixing chamber 50 via the inlet openings 56 in the baffle 55. Therein, a diameter of the jet entering the mixing chamber 50 is significantly smaller than the diameter of the cylindrical portion 60 of the mixing chamber 50, since the diameter of the inlet opening 56 is also essentially smaller than the diameter of the cylindrical portion 60. As a result, a negative pressure is produced in the cylindrical portion 60, causing air to enter into the mixing chamber 50 from the annular gap space 70 via the air ventilation openings 52 and to admix with the liquid jet. A frustoconical enlargement 62 of the mixing chamber 50 adjoins the cylindrical portion 60. Then, the conical enlargement 62 passes into two outlet chambers 66 and 68. The outlet openings 30, 32 are cut in the outlet chambers 66 and 68. In the outlet chambers 66 and 68, there is a coarse drop distribution of liquid present, which liquid is then outputted via the outlet openings 30, 32, in each case in the form of a flat jet.

There is an annular gap space 70 produced between the injector component 36 and the housing 26, which gap space is vented via the air ventilation openings 76 from the environment. Environmental air is supplied to the intake openings 52 via said annular gap space 70.

The injector component 36 further has a housing portion with a circumferential groove 72, wherein an O-ring made of elastic material is placed. By means of the O-ring, the injector component 36 is held within the housing 26. The O-ring rests on the inner wall of the interior space 51, and the diameter of the injector component 36 above and below the groove 72 is slightly smaller than the diameter of the circular cylindrical interior space 51. During inserting the injector component 36, said component is, thus, guided by means of the zones above and below the groove 72 in the interior space 51.

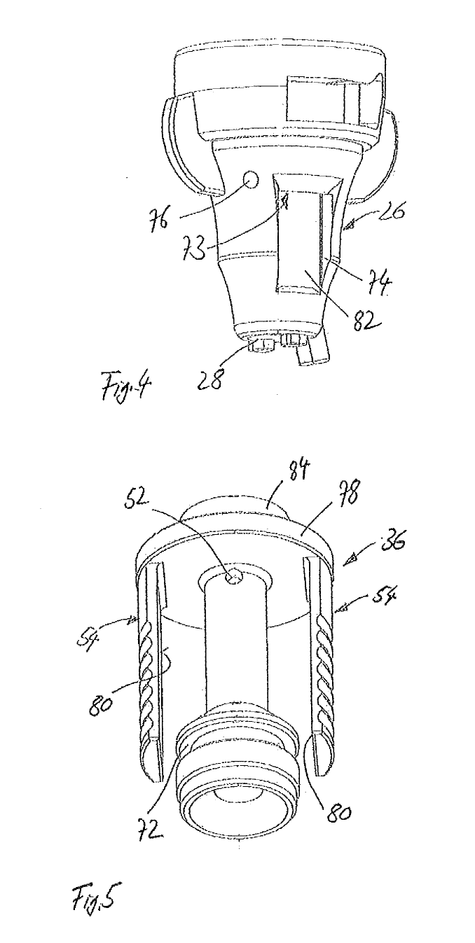

The illustration according to FIG. 4 shows the housing 26 with the mouthpiece 28 inserted therein. The housing 26 has the two rectangular through holes 74 located diametrically opposite one to the other, through which holes the outer wall 82 of the circular cylindrical interior space 51 is visible. Located between said outer wall 82 and the remainder of the housing 26 there is, cf. FIG. 2, a respective slot 73 through which then the operating pieces 54 of the injector component 36 are inserted. The location of said slots 73 ensures the correct orientation of the injector component 36 in the housing 26 at the same time. By reaching through the through holes 74, a user may grasp the handle portions 44 of the operating pieces 54 of the injector component 36 provided with corrugations, in order to push the injector component 36 completely into the housing 26 or to push it back out of the housing 26 again. The outer wall 82 is planar, the inner wall bordering the interior space 51 is circular cylindrical in shape.

In FIG. 4, there is one of the air ventilation openings 76 visible in the housing 26, which are to connect the annular gap space 70 to the environment, cf. FIG. 3.

The illustration of FIG. 5 shows the injector component 36. The two operating pieces 54 are connected to the mixing chamber portion of the injector component 36 by means of an annular flange 78. As a result, the operating pieces 54 are arranged at a distance to the mixing chamber portion. An inner surface 80 of the operating pieces 54 facing the mixing chamber portion is planar. Similarly, the portion 82 of the outer wall of the interior chamber 51, which portion is visible through the through holes 74, cf. FIG. 4, is planar. Thus, the inner surfaces 80 can smoothly slide on the planar portions 82 of the outer wall of the interior chamber 51 such that pushing in and pushing out of the injector component 36 without using a tool is readily possible.

The annular flange 78 is provided with a circumferential collar 84 on its upstream located side, which collar is a recess in circular cylindrical shape, cf. FIG. 2, wherein the baffle 55 can be inserted, cf. FIG. 3. In the completely assembled state of the injector component 36 a downstream located bottom side of the annular flange 78 is resting on an annular step of the housing 26, cf. FIG. 3, and thereby defines a completely inserted position of the injector component 36. On an upstream located upper side of the annular flange 78, there is an annular seal 86 arranged, which seal provides sealing of the housing 26, when the housing is placed on the nozzle support 22, cf. FIG. 1.

In FIG. 5 there is yet another of the air ventilation openings 52 leading into the mixing chamber 50 visible. The groove 72 of the injector component 36 is shown without an O-ring in the illustration according to FIG. 5.

1. An injector nozzle having a housing and having an injector component arranged in the interior space of the housing at least in sections,
wherein
the injector component has at least one handle portion which is accessible from an outer side of the housing.

2. The injector nozzle according to claim 1, wherein the housing has at least one through hole, wherein the at least one through hole is appropriate for a human finger to reach in, at least in sections, and wherein the handle portion of the injector component is accessible via the through hole.

3. The injector nozzle according to claim 1, wherein the housing has two opposite through holes.

4. The injector nozzle according to claim 2, wherein the at least one through hole is in a rectangular or oval shape.

5. The injector nozzle according to claim 1, wherein the injector component has corrugations at least in a region that is located in the vicinity of the at least one through hole of the housing in the assembled state.

6. The injector nozzle according to claim 1,
wherein the injector component has a mixing chamber housing which together with an inner wall of the nozzle housing constitutes an air intake compartment, and at least one operating piece including the handle portion disposed at a distance to the mixing chamber housing and arranged in the vicinity of the at least one through hole of the housing, in the assembled state of the injector component.

7. The injector nozzle according to claim 6, wherein the housing has two opposite through holes and the injector component has two opposite operating pieces, each piece provided with a handle portion.

8. The injector nozzle according to claim 6, wherein the at least one operating piece including the handle portion extends from a flange connected to the mixing chamber housing and projects freely from the flange.
